(19) United States
(12) Patent Application Publication
(10) Pub. No.: US 2023/0419393 A1
(43) Pub. Date: Dec. 28, 2023

(54) SYSTEM AND METHOD OF MONITORING RENTAL HISTORY

(71) Applicant: Jerry Calonge, Hempstead, NY (US)

(72) Inventor: Jerry Calonge, Hempstead, NY (US)

(21) Appl. No.: 18/210,748

(22) Filed: Jun. 16, 2023

Related U.S. Application Data
(60) Provisional application No. 63/355,029, filed on Jun. 23, 2022.

(51) Int. Cl. G06Q 30/0645

(52) U.S. Cl. CPC G06Q 30/0645

(57) ABSTRACT

A computer-implemented method of recording voter selections includes receiving data of a rental history for a tenant. The data of the rental history for the tenant includes at least two data sets selected from past rent owed, payment history, length of time at a previous residence, history of the tenant being a primary renter, history of the tenant being a co-tenant, history of the tenant being a co-signer, occurrences of judgments against the tenant, or behavior of the tenant at the previous residence. The method includes assigning a category score to each data set of the at least two data sets using a convolutional neural network (CNN). The CNN determines an average category score for the data sets by averaging the assigned category scores for the data sets. A rental credit score is generated based on the determined average category score for the data sets.

### CROSS-REFERENCE TO RELATED APPLICATION

The present application claim priority to U.S. Provisional Patent Application No. 63/355,029, filed on Jun. 23, 2022, the entire contents of which are incorporated by reference herein.

### FIELD

The present disclosure relates to rental history and, more particularly, to a system and method of monitoring rental history.

### BACKGROUND

Screening of potential tenants is a process generally employed by residential landlords and property managers to evaluate prospective tenants. The primary purpose of tenant screening is to assess the likelihood the tenant will fulfill the terms of the lease or rental agreement and will also reasonably maintain the rental property in question, and/or notify the landlord of any actual or potential issues in need of repair. As an example, a background check may be performed to identify tenants with a history of nonpayment or a history of causing damage to a property.

Tenant screening generally culminates in a decision as to whether to approve the applicant, approve the applicant conditionally (such as requiring an increased deposit or cosigner), or deny tenancy.

However, the amount of information that is available through a traditional background check is limited, and often incomplete. For example, many instances of nonpayment go unreported and are therefore not readily identified in a conventional background check performed by a landlord.

### SUMMARY

Provided in accordance with aspects of the present disclosure is a computer-implemented method of monitoring rental history. The method includes receiving data of a rental history for a tenant. The data of the rental history for the tenant includes at least two data sets selected from past rent owed, payment history, length of time at a previous residence, history of the tenant being a primary renter, history of the tenant being a co-tenant, history of the tenant being a co-signer, occurrences of judgments against the tenant, or behavior of the tenant at the previous residence. The method includes assigning a category score to each data set of the at least two data sets using a convolutional neural network (CNN). The CNN determines an average category score for the data sets by averaging the assigned category scores for the data sets. A rental credit score for the tenant is generated based on the determined average category score for the at least two data sets.

In an aspect of the present disclosure, the determined average score is weighted to generate a weighted rental credit score for the tenant.

In an aspect of the present disclosure, the method includes identifying a time factor for at least one category score. The category score is modified based on the time factor.

In an aspect of the present disclosure, a behavior score for the tenant is assigned based on the behavior of the tenant at the previous residence. The weighted rental credit score is modified based on the behavior score.

In an aspect of the present disclosure, a weight is assigned to the category score for each data set. A time factor is identified for at least one category score. An assigned weight is modified based on the time factor. A weighted credit score is generated for the tenant based on the modified weight.

In an aspect of the present disclosure, each category score is weighted and a weighted rental credit score for the tenant is generated based on a sum of the weighted category scores.

In an aspect of the present disclosure, the method includes receiving updated data of the rental history for the tenant. The updated data includes at least two updated data sets having data selected from past rent owed, payment history, length of time at at least one previous residence, history of the tenant being a primary renter, history of the tenant being a co-tenant, history of the tenant being a co-signer, occurrences of judgments against the tenant, or behavior of the tenant at the at least one previous residence. The method includes assigning an updated category score to each updated data set. The method includes determining an updated average category score for the updated data sets by averaging the assigned updated category scores for each updated data set. An updated rental credit score is generated for the tenant based on the determined average updated category score.

In an aspect of the present disclosure, the method includes transmitting the rental credit score or the updated rental credit score to a lender or insurance provider.

In an aspect of the present disclosure, the method includes generating a non-fungible token (NFT) including the rental credit score for the tenant. The NFT is authenticated using a blockchain.

### BRIEF DESCRIPTION OF THE DRAWINGS

Various aspects and features of the present disclosure are described hereinbelow with reference to the drawings wherein:

FIG. 1 is a flowchart of a method of monitoring rental history according to aspects of the present disclosure;

FIG. 2 is a flowchart of a method of monitoring rental history according to aspects of the present disclosure;

FIG. 3 is a flowchart of a method of monitoring rental history according to aspects of the present disclosure;

FIG. 4 is a flowchart of a method of monitoring rental history according to aspects of the present disclosure;

FIG. 5 is a flowchart of a method of monitoring rental history according to aspects of the present disclosure;

FIG. 6 is a flowchart of a method of monitoring rental history according to aspects of the present disclosure;

FIG. 7 is a block diagram of an exemplary computer for implementing the method of monitoring rental history according to aspects of the present disclosure.

### DETAILED DESCRIPTION

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Exemplary configurations of the disclosure will be described more fully below (e.g., with reference to the accompanying drawings). Like reference numerals may refer to like elements throughout the specification and drawings.

The system and method of monitoring rental history described herein may be a cloud-based application that is accessible through a device such as a smartphone, tablet computer, or laptop computer, or through a specialized hardware device.

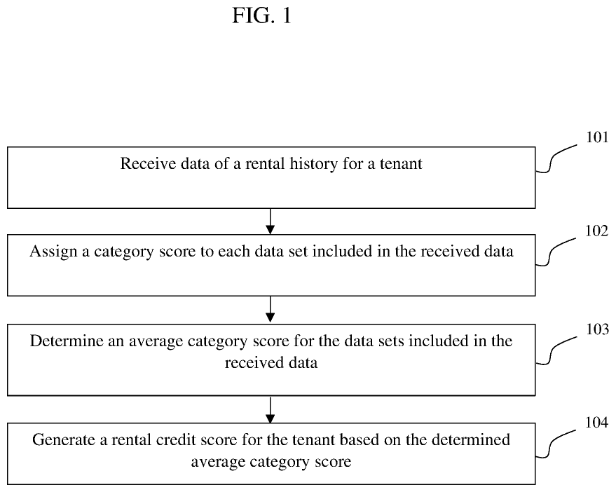

Referring particularly to FIG. 1, a computer-implemented method of monitoring rental history includes receiving data of a rental history for a tenant 101. The data of the rental history for the tenant includes at least two data sets selected from past rent owed, payment history, length of time at a previous residence, history of the tenant being a primary renter, history of the tenant being a co-tenant, history of the tenant being a co-signer, occurrences of judgments against the tenant, or behavior of the tenant at the previous residence.

A category score is assigned to each data set 102 using a neural network, such as a convolutional neural network (CNN). The CNN determines an average category score for the data sets 103 by averaging the assigned category scores for the data sets. A rental credit score for the tenant is generated based on the determined average category score 104 for the at least two data sets.

While a CNN may be employed, as described herein, other machine learning models may similarly be employed. The machine learning model may be trained on tagged data, such as previously generated rental credit scores. The trained CNN, trained machine learning model, or other form of decision or classification processes can be used to implement one or more of the methods, functions, processes, algorithms, or operations described herein. A neural network or deep learning model can be characterized in the form of a data structure storing data representing a set of layers containing nodes, and connections between nodes in different layers are formed or created that operate on an input to provide a decision or value as an output (e.g., a score or weight, as described herein).

Machine learning can be employed to enable the analysis of data and assist in making decisions. To benefit from using machine learning, a machine learning algorithm is applied to a set of training data and labels to generate a “model” which represents what the application of the algorithm has “learned” from the training data. Each element (e.g., one or more parameters, variables, characteristics or “features”) of the set of training data is associated with a label or annotation that defines how the element should be classified by the trained model. A machine learning model predicts a defined outcome based on a set of features of an observation. The machine learning model is built by being trained on a dataset which includes features and known outcomes. There are various types of machine learning algorithms, including linear models, support vector machines (SVM), random forest, and/or XGBoost. A machine learning model may include a set of layers of connected neurons that operate to decide (e.g., a classification) regarding a sample of input data. When trained (e.g., the weights connecting neurons have converged and become stable or within an acceptable amount of variation), the model will operate on new input data to generate the correct label, classification, weight, or score as an output. Other suitable machine learning models may be similarly employed.

In an aspect of the present disclosure, the determined average score is weighted to generate a weighted rental credit score for the tenant. The weighted rental credit score can have an increased or decreased value with respect to the rental credit score that is generated based on the average category score. The weighted credit score is determined by applying a weighted value to each category score, multiplying the category score by the weighted value, and determining a sum of the category scores multiplied by the weighted value. As an example, a relatively high weight may be placed on the data sets of past rent owed and past payment history. For example, a renter with many years of rent owed, and a 100% payment history of the rent owed would be assigned a high category score for each of the past rent owed and the payment history data sets, and the category score would be highly weighted. Alternatively, a relatively low weight may be assigned to a data set with the tenant as a co-signer or as a co-tenant if it is believed that such data sets are of relatively lower predictive value of a renters future behavior.

A sum of the weighted values applied to each category score may add up to 1.0, so that a 100% total weight can be distributed, as desired, amongst the available category scores.

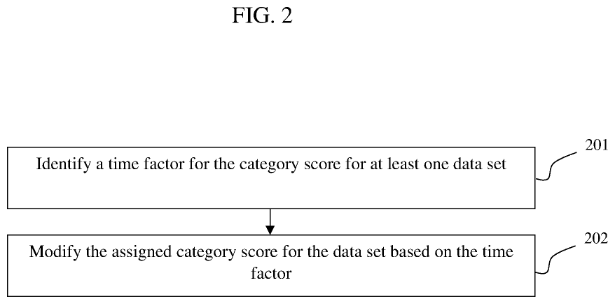

Referring particularly to FIG. 2, the method includes identifying a time factor for at least one category score 201. The category score can be modified based on the time factor 202. For example, a category score having a time factor with a greater value (e.g., a data set, such as rental payment history over a relatively long period of time) would have a time factor with a relatively high value, compared with a time factor indicative of a shorter rental history.

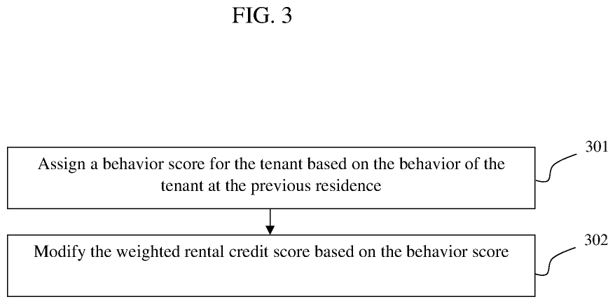

Referring particularly to FIG. 3, a behavior score for the tenant is assigned based on the behavior of the tenant at the previous residence 301. The weighted rental credit score is modified based on the behavior score 302. For example, the weighted rental score may be increased when the behavior score is relatively high, or reduced if a behavior score is relatively low. The behavior score can be an indication of the behavior of the tenant while residing at a particular property. For example, the behavior score may include a rating of how clean a property was upon a tenant vacating the property, or an absence of any damage to the property during a tenant's occupancy. As an example, a percent value may be applied to a number of factors (e.g., amount of damage, maintenance of property, appearance of outside of property, responsiveness to landlord inquiries, or promptness of reporting an issue or potential issue in need of repair), and an average may be taken of each percent value to arrive at a behavior score between 0.1 and 1.0.

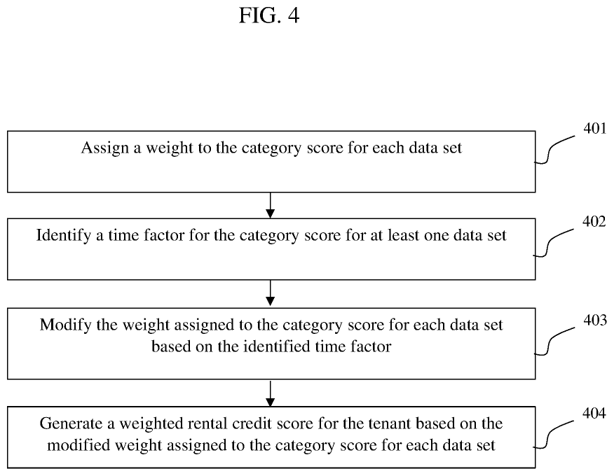

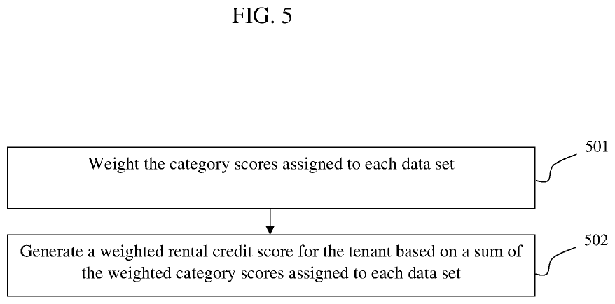

Referring particularly to FIGS. 4 and 5, a weight is assigned to the category score for each data set 401. A time factor is identified for at least one category score 402. An assigned weight is modified based on the time factor 403. A weighted credit score is generated for the tenant based on the modified weight 404. That is, a weight value may be increased proportionally with a time value (i.e., a weight will increase as the underlying time period increases).

Referring particularly to FIG. 5, the category score for each data set may be weighted 501 and a weighted rental credit score may be generated for the tenant based on a sum of the weighted category scores assigned to each data set 502.

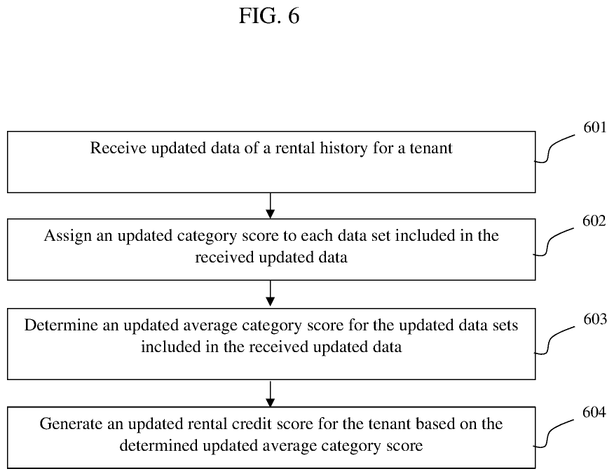

Referring particularly to FIG. 6, the rental credit scores (weighted or unweighted) described herein may be periodically and dynamically updated. Updates may be performed at any predetermined time points and/or at any point that additional data is received. To dynamically update the rental credit scores described herein, updated data of the rental history for the tenant is received 601. The updated data includes at least two updated data sets having data selected from past rent owed, payment history, length of time at at least one previous residence, history of the tenant being a primary renter, history of the tenant being a co-tenant, history of the tenant being a co-signer, occurrences of judgments against the tenant, or behavior of the tenant at the at least one previous residence.

An updated category score is assigned to each updated data set 602. An updated average category score is determined for the updated data sets by averaging the assigned updated category scores for each updated data set 603. An updated rental credit score is generated for the tenant based on the determined average updated category score 604.

In an aspect of the present disclosure, the rental credit score or the updated rental credit score, as described herein, is transmitted to a lender or insurance provider.

In an aspect of the present disclosure, the method includes generating a non-fungible token (NFT) including the rental credit score for the tenant. The NFT is authenticated using a blockchain.

The data of the rental history of the tenant may include data of any legal judgments, past or pending litigation matters, liens, criminal history, or other publicly available information. For example, any judgments or pending matters in a housing court may be identified and received as rental history data.

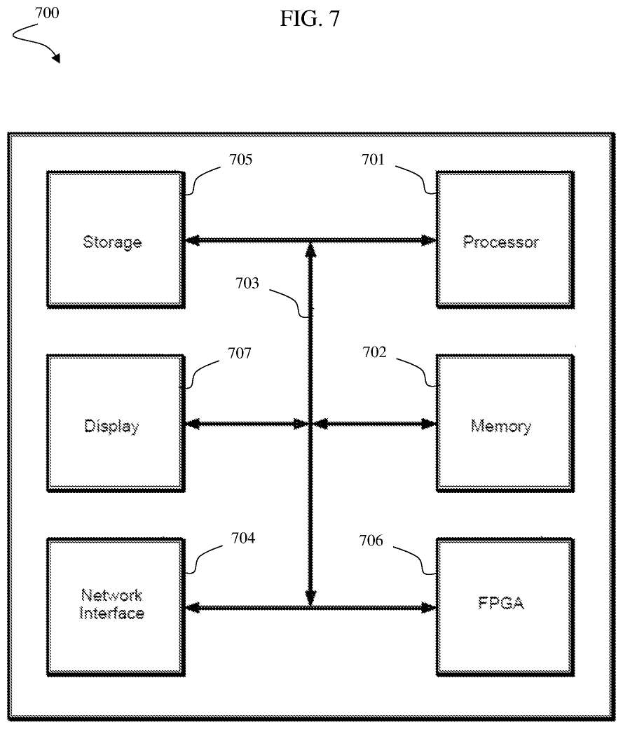

Referring particularly to FIG. 7, a general purpose computer 700 is described. The general purpose computer 700 can be employed to perform the various methods and algorithms described herein. The computer 700 may include a processor 701 connected to a computer-readable storage medium or a memory 702 which may be a volatile type memory, e.g., RAM, or a non-volatile type memory, e.g., flash media, disk media, etc. The processor 701 may be another type of processor such as, without limitation, a digital signal processor, a microprocessor, an ASIC, a graphics processing unit (GPU), field-programmable gate array (FPGA), or a central processing unit (CPU).

In some aspects of the disclosure, the memory 702 can be random access memory, read-only memory, magnetic disk memory, solid state memory, optical disc memory, and/or another type of memory. The memory 702 can communicate with the processor 701 through communication buses 703 of a circuit board and/or through communication cables such as serial ATA cables or other types of cables. The memory 702 includes computer-readable instructions that are executable by the processor 701 to operate the computer 700 to execute the algorithms described herein. The computer 700 may include a network interface 704 to communicate (e.g., through a wired or wireless connection) with other computers or a server. A storage device 705 may be used for storing data. The computer 700 may include one or more FPGAs 706. The FPGA 706 may be used for executing various machine learning algorithms. A display 707 may be employed to display data processed by the computer 700.

A system for monitoring rental history, and facilitating property rental transactions, property management, and assessing performance of landlords and tenants is described in U.S. patent application Ser. No. 12/381,956, published as U.S. Patent Application Publication No. US2009/0240565A1, the entire contents of which are hereby incorporated by reference.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

What is claimed is:

1. A computer-implemented method of monitoring rental history, the method comprising:
receiving data of a rental history for a tenant, the data of the rental history for the tenant including at least two data sets selected from past rent owed, payment history, length of time at a previous residence, history of the tenant being a primary renter, history of the tenant being a co-tenant, history of the tenant being a co-signer, occurrences of judgments against the tenant, or behavior of the tenant at the previous residence;
assigning a category score to each data set of the at least two data sets using a convolutional neural network (CNN);
determining, by the CNN, an average category score for the at least two data sets by averaging the assigned category scores for each data set of the at least two data sets; and
generating a rental credit score for the tenant based on the determined average category score for the at least two data sets.

2. The method of claim 1, further including weighting, by the CNN, the determined average score to generate a weighted rental credit score for the tenant.

3. The method of claim 2, further including:
identifying, by the CNN, a time factor for the category score for at least one data set of the at least two data sets; and
modifying the assigned category score for the at least one data set of the at least two data sets based on the time factor.

4. The method of claim 3, further including:
assigning, by the CNN, a behavior score for the tenant based on the behavior of the tenant at the previous residence; and
modifying the weighted rental credit score based on the behavior score.

5. The method of claim 2, further including:
assigning, by the CNN, a behavior score for the tenant based on the behavior of the tenant at the previous residence; and
modifying the weighted rental credit score based on the behavior score.

6. The method of claim 1, further including:
assigning, by the CNN, a weight to the category score for each data set of the at least two data sets;
identifying, by the CNN, a time factor for the category score for at least one data set of the at least two data sets;
modifying, by the CNN, the weight assigned to the category score for each data set of the at least two data sets based on the identified time factor; and
generating a weighted rental credit score for the tenant based on the modified weight assigned to the category score for each data set of the at least two data sets.

7. The method of claim 1, further including:
weighting, by the CNN, the category scores assigned to each data set of the at least two data sets; and
generating, by the CNN, a weighted rental credit score for the tenant based on a sum of the weighted category scores assigned to each data set of the at least two data sets.

8. The method of claim 1, further including:
receiving updated data of the rental history for the tenant, the updated data of the rental history for the tenant including at least two updated data sets having data selected from past rent owed, payment history, length of time at at least one previous residence, history of the tenant being a primary renter, history of the tenant being a co-tenant, history of the tenant being a co-signer, occurrences of judgments against the tenant, or behavior of the tenant at the at least one previous residence;
assigning, by the CNN, an updated category score to each updated data set of the at least two updated data sets;
determining, by the CNN, an updated average category score for the at least two updated data sets by averaging the assigned updated category scores for each updated data set of the at least two updated data sets; and
generating an updated rental credit score for the tenant based on the determined average updated category score for the at least two updated data sets.

9. The method of claim 8, further including transmitting the updated rental credit score to a lender or insurance provider.

10. The method of claim 1, further including transmitting the rental credit score to a lender or insurance provider.

11. The method of claim 1, further including generating a non-fungible token (NFT) including the rental credit score for the tenant, wherein the NFT is authenticated using a blockchain.

12. A method of monitoring rental history, the method comprising:
receiving data of a rental history for a tenant, the data of the rental history for the tenant including at least two data sets selected from past rent owed, payment history, length of time at a previous residence, history of the tenant being a primary renter, history of the tenant being a co-tenant, history of the tenant being a co-signer, occurrences of judgments against the tenant, or behavior of the tenant at the previous residence;
assigning a category score to each data set of the at least two data sets;
determining an average category score for the at least two data sets by averaging the assigned category scores for each data set of the at least two data sets; and
generating a rental credit score for the tenant based on the determined average category score for the at least two data sets.

13. The method of claim 12, further including weighting the determined average score to generate a weighted rental credit score for the tenant.

14. The method of claim 13, further including:
identifying a time factor for the category score for at least one data set of the at least two data sets; and
modifying the assigned category score for the at least one data set of the at least two data sets based on the time factor.

15. The method of claim 14, further including:
assigning a behavior score for the tenant based on the behavior of the tenant at the previous residence; and
modifying the weighted rental credit score based on the behavior score.

16. The method of claim 13, further including:
assigning a behavior score for the tenant based on the behavior of the tenant at the previous residence; and
modifying the weighted rental credit score based on the behavior score.

17. The method of claim 12, further including:
assigning a weight to the category score for each data set of the at least two data sets;
identifying a time factor for the category score for at least one data set of the at least two data sets;
modifying the weight assigned to the category score for each data set of the at least two data sets based on the identified time factor; and
generating a weighted rental credit score for the tenant based on the modified weight assigned to the category score for each data set of the at least two data sets.

18. The method of claim 12, further including:
weighting the category scores assigned to each data set of the at least two data sets; and
generating a weighted rental credit score for the tenant based on a sum of the weighted category scores assigned to each data set of the at least two data sets.

19. The method of claim 12, further including:
receiving updated data of the rental history for the tenant, the updated data of the rental history for the tenant including at least two updated data sets having data selected from past rent owed, payment history, length of time at at least one previous residence, history of the tenant being a primary renter, history of the tenant being a co-tenant, history of the tenant being a co-signer, occurrences of judgments against the tenant, or behavior of the tenant at the at least one previous residence;
assigning an updated category score to each updated data set of the at least two updated data sets;
determining an updated average category score for the at least two updated data sets by averaging the assigned updated category scores for each updated data set of the at least two updated data sets; and
generating an updated rental credit score for the tenant based on the determined average updated category score for the at least two updated data sets.

20. The method of claim 19, further including transmitting the updated rental credit score to a lender or insurance provider.
